(19) United States
(12) Patent Application Publication
(10) Pub. No.: US 2010/0163514 A1
(43) Pub. Date: Jul. 1, 2010

(54) APPARATUS AND METHOD FOR COMPRESSION MOULDING PARISONS AND BLOW MOULDING MULTI LAYERED BOTTLES

(76) Inventor: Jan Petrus Human, Somerset West (ZA)

Correspondence Address: STITES & HARBISON PLLC, 1199 NORTH FAIRFAX STREET, SUITE 900, ALEXANDRIA, VA, 22314, US

(21) Appl. No.: 12/278,870

(22) PCT Filed: Feb. 8, 2007
(86) PCT No.: PCT/IB07/00294

§ 371 Date: Aug. 8, 2008

(30) Foreign Application Priority Data
Feb. 8, 2006 (ZA) 2006/1106

(51) Int. Cl. B65D 90/02; B29C 43/04

(52) U.S. Cl. 215/379; 425/355; 264/325

(57) ABSTRACT

Compression moulding apparatus is described in which the female mould (18) has a vertical passageway (22) through it. The male mould (20) has surfaces (24) for sealingly engaging corresponding surfaces (26) on the female mould. A plunger (28) comprising a shaft (30) and a ring (32) is provided below the female mould. The ring and shaft form a well (34) for receiving a charge (38) of plastics material which is lifted into the female mould by the shaft. The shaft also exerts the moulding pressure.

### FIELD OF THE INVENTION

THIS INVENTION relates to compression moulding apparatus and to a compression moulding method.

### BACKGROUND TO THE INVENTION

The general background to compression moulding is described in the specification of my earlier PCT application PCT/ZA2004/00082 (published as WO 2005/009716). Various forms of compression moulding are disclosed in U.S. Pat. Nos. 4,913,871, 4,649,013, 5,776,381, 4,595,550 and 5,204,127 as well as in UK Specification 2 480 667, French Specification 2480667 and Japanese patent publication 20022047016.

The apparatus of WO 2005/009716 is able to handle most forms of molten synthetic plastics materials and produce articles such as bottle caps.

A particularly difficult plastics material to handle is PET. This is now widely used to manufacture bottles by blowing preforms. Such preforms are injection moulded as PET can be handled successfully in an injection moulding machine.

In compression moulding a charge of molten plastics material is cut-off a supply and dropped as a bead into a female mould. PET is a viscous liquid once molten and has a tendency to form strings when manipulated in molten form. In compression moulding these strings drape themselves over the female mould. This problem prevents PET being used on a commercial scale in compression moulding.

The present invention is an improvement on the invention of WO 2005/009716 and its main object is to provide compression moulding apparatus and a compression moulding method which will handle PET so that products such as PET preforms can be manufactured by compression moulding.

### BRIEF DESCRIPTION OF THE INVENTION

According to the present invention there is provided compression moulding apparatus which comprises a female mould with a vertical passageway therethrough, a male mould which is above the female mould, means for displacing the male mould and female mould into contact to close the upper end of said passageway and partially to define a mould cavity within the female mould, a plunger, means for displacing the plunger and female mould relatively to one another so that the plunger enters the lower end of said passageway, the upper end of the plunger being in the form of a well for receiving a charge of synthetic plastics material before the plunger enters said passageway, and means for feeding a charge of synthetic plastics material to said well.

Said well in one form is constituted by a depression in the top surface of said plunger. In another form said plunger comprises a shaft and a ring, the radially inner surface of the ring and the top surface of the shaft constituting said well whilst the ring protrudes upwardly above the top surface of said shaft.

Means are preferably provided for displacing said male mould up and down with respect to the female mould and for displacing said plunger up and down with respect to the female mould.

According to another aspect of the present invention there is provided a compression moulding method which comprises bringing a male mould member and female mould member into contact whereby the male mould member closes the upper end of a passageway extending through the female mould member, surfaces of the contacting mould members constituting part of the bounding wall of a mould cavity, feeding a charge of synthetic plastics material onto the top surface of a plunger, inserting the plunger into the lower end of said passageway thereby to place said charge of synthetic plastics material in said passageway, displacement of said plunger and the female mould relatively to one another continuing until the upper surface of the plunger reaches a position in which it constitutes the remaining part of the bounding wall of the mould cavity.

In the preferred form of the method the male mould member moves downwardly towards said female mould member to close said upper end of said passageway, and the plunger moves upwardly towards said female mould member to insert said charge of plastics material into the passageway.

According to a further aspect of the present invention there is provided a method of producing a bottle the wall of which comprises more than one layer of synthetic plastics material, the method comprising moulding a first preform which is open at one end and closed at the other, moulding a second preform which is open at one end and closed at the other, the external dimensions of the second preform being compatible with the internal dimensions of the first preform, inserting the second preform into the first preform and blowing the preforms to form the bottle.

The first preform can have a radially outwardly protruding flange adjacent the open end thereof. In another form the internal dimension of the first preform can be greater adjacent its open end than elsewhere whereby there is an annular gap between the first and second preforms adjacent the open end of the first preform.

To enable a cap to be fitted the second preform can have threading on the external surface thereof adjacent said open end and an encircling cap retaining bead positioned between the threading and the remainder of the preform.

Two second preforms can be inserted into the first preform whereby the bottle blown has an internal partition.

The invention also provides a blown bottle having a multi-layer wall when produced by the above method.

### BRIEF DESCRIPTION OF THE DRAWINGS

For a better understanding of the present invention, and to show how the same may be carried into effect, reference will now be made, by way of example, to the accompanying drawings in which:

FIG. 1 is sequence drawing illustrating a moulding cycle;

FIG. 2 is an axial section through a first preform;

FIG. 3 is an axial section through a second preform;

FIG. 4 is an axial section showing the preforms of FIGS. 2 and 3 nested in one another;

FIG. 5 illustrates a further form of preform;

FIG. 6 illustrates the moulding of a preform; and

FIG. 7 illustrates the production of a bottle with an internal partition in it.

### DETAILED DESCRIPTION OF THE DRAWINGS

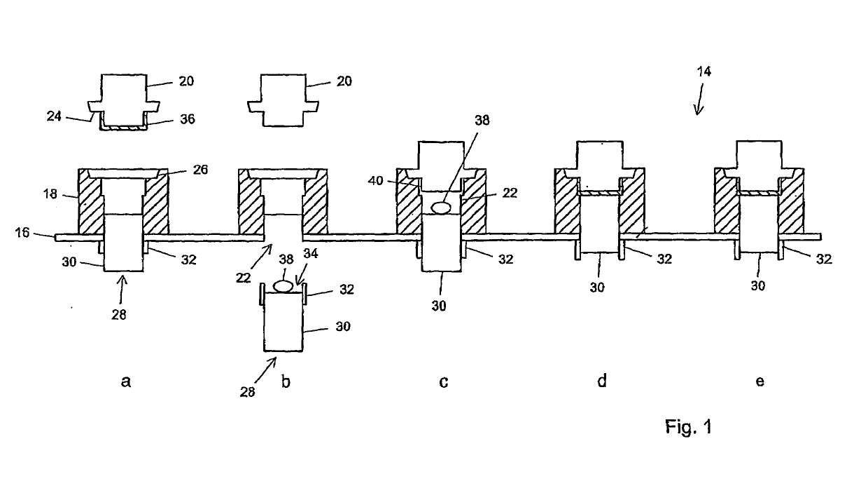

Referring firstly to FIG. 1 reference numeral 14 designates a rotatable carousel. Reference number 16 designates a rotatable disc to which a plurality of female moulds 18 are secured. The apparatus further includes a plurality of male moulds 20 which rotate with the female moulds 18.

The female moulds 18 are open both at their upper ends and at their lower ends so that there is, at the stage in the moulding procedure Illustrated in FIG. 1b, a vertical passageway 22 through the female mould.

Each male mould 20 has mould cavity closing surfaces 24 and each female mould 18 has surfaces 26 which co-operate with the surfaces 24. Once these surfaces are in contact the male and female mould members do not move again with respect to one another until the moulding procedure Is complete and the mould is to be opened.

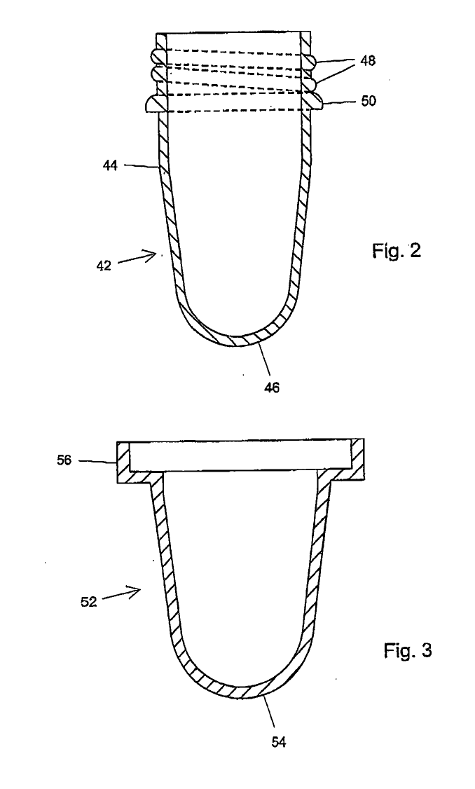

The apparatus further includes a plurality of plungers 28. Each plunger 28 comprises a shaft 30 and a ring 32. Cams, not shown, are provided for reciprocating the plungers 28 vertically with respect to the female moulds 18. The ring 32 can slide, with respect to the shaft 30, from the uppermost position shown in FIG. 2b to the lowermost position shown in FIGS. 1d and 1e. When the shaft 30 and ring 32 are as shown in FIG. 2b, the radially inner surface of the ring 32 and the top surface of the plunger 30 form a well designated 34.

The sequence of moulding operations will now be described in detail.

In FIG. 1a, the male mould 20 has been withdrawn upwardly from the female mould 18. The cap 36 moulded during the previous cycle is attached to the male mould. Between the positions on the carousel shown in FIGS. 1a and 1b, the cap 36 is forced-off the male mould and ejected onto a conveyer.

In FIG. 1a the upper part of the shaft 30 of the plunger 28 is still within the female mould 18. The ring 32 is against the underside of the disc 16.

The shaft 30 is then cammed down to its lowermost position and the ring 32 is cammed to the position in which it protrudes upwardly from the shaft 30 to form the well 34.

The charge 38 of synthetic plastics material is then fed into the well 34.

As the moulds move from the position of FIG. 1b to that of FIG. 1c, the plunger 28 lifts so that the shaft 30 enters the open lower end of the passageway 22 of the female mould 18. Once the ring 32 encounters the underside of the disc 16, the shaft 30 moves upwardly with respect to the ring 32. Simultaneously with upward movement of the plunger 28, the male mould 20 moves downwards until its surfaces 24 bear on the female mould's surfaces 26 to seal-off the mould cavity which has been designated 40 in FIG. 1c. The mould cavity 40 is at this stage extended downwardly by the passageway 22 in the female mould 18. The lower end of the downward extension of the mould cavity 40 is constituted by the top surface of the shaft 30. Upward movement of the shaft 30 from the position shown in FIG. 1c to the position shown in FIG. 1d forces the synthetic plastics material into the mould cavity 40 to form the next cap 36. The shaft 30 thus exerts the moulding pressure. FIG. 1e represents the cooling stage. After the cooling stage, the male and female moulds separate and the position of FIG. 1a is reached. The next cycle then begins.

FIG. 2 illustrates a preform, designated 42, from which a bottle can be blown. The preform 42 comprises a main body 44 which has a hemispherical lower end 46. Threading which enables a cap (not shown) to be screwed onto the preform is shown at 48 and a cap retaining bead is shown at 50.

The preform is preferably of the material which is referred to as PET.

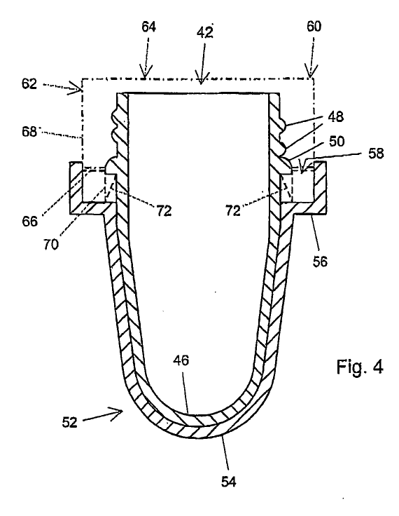

A second preform is shown at 52 in FIG. 3. The dimensions of the second preform 52 are such that the preform 42 can fit inside it as shown in FIG. 4. The preform 52 does not have threading 48 or a retaining bead 50. The preform 52 is closed at its lower end by a hemispherical end wall 54 and is open at its upper end. Immediately adjacent the open upper end of the generally tubular body of the preform 52 there is a flange 56 which extends outwardly and then upwardly so that, when the preform 42 is inserted into the preform 52, there is an annular recess 58 (FIG. 4) between the two preforms.

Once the two preforms are nested as shown in FIG. 4, they are placed in a blow mould. The upper parts of the nested preforms are gripped externally by the blow mould and a core is inserted into the upper end of the nested preforms. The blow mould has a configuration such that the upper parts of the nested preforms are prevented from changing shape during blowing. Air is blown in through a bore in the core and the tubular bodies of the preforms are heated so that they expand to the shape of the blow mould.

A closure cap 60 is shown in chain dotted lines in FIG. 4. The cap 60 has a skirt 62 and a transverse end wall 64. A line of weakening 66 is provided in the skirt 62 thereby to provide a skirt main portion 68 and an end ring 70. Retaining teeth 72 of triangular shape protrude inwardly from the ring 68. The end ring 70, the line of weakening 66 and the part of the skirt 62 immediately adjacent the line of weakening 66 are in the recess 58 and are thus inaccessible. The retaining teeth 72 are below the bead 50 and prevent the cap 60 being removed without breaking the cap along the line of weakening 66. This separates the end ring 70 from the main portion 68 of the skirt 62 and reveals that tampering has taken place.

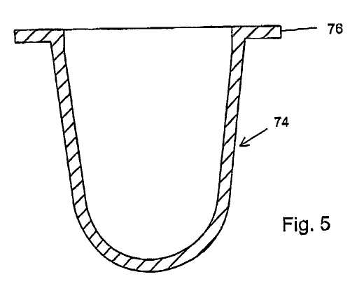

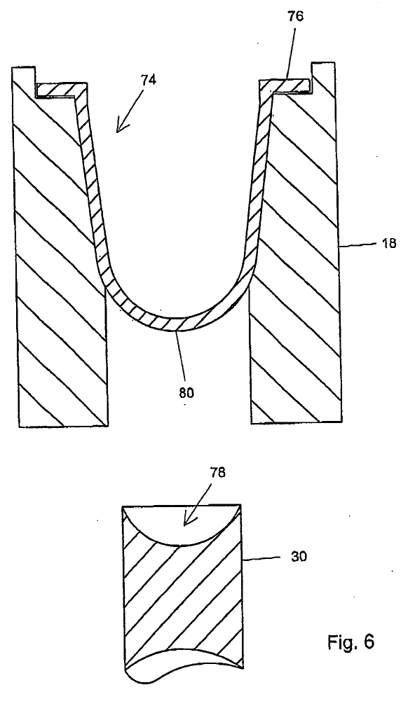

The preform 74 of FIG. 5 is similar in shape to that of FIG. 3. It differs, however, in that it has, around its open upper end, an outwardly protruding flange 76.

During blowing, the radially outer part of the flange 76 is turned upwardly so that the flange 76 takes on the same shape as the flange 56 of FIG. 3 and has the same function.

By the way of example, moulding of the preform 74 is illustrated in FIG. 6. All the other preforms described can be moulded in the same way.

The upper end of the shaft 30 has a hemispherical depression 78 in it. This moulds the end wall 80 of the preform 74 and, when completely filled, provides sufficient material to mould the preform. The depression 78 thus acts as a measuring vessel.

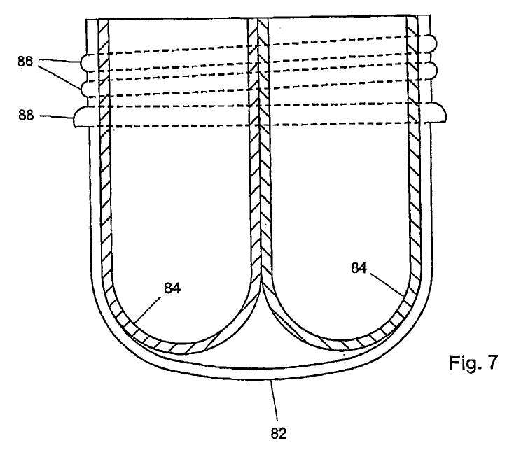

Turning finally to FIG. 7, this shows an outer preform 82, and two inner preforms 84 nested within the preform 82. The preform 82 has threading 86 and a bead 88. It can also have a flange such as shown at 56 in FIG. 3 or 76 in FIG. 5. When the three preforms are heated, and air blown in via the cores in the necks of the preforms 84, the three preforms expand to provide a bottle with an internal partition and two separate compartments. Air between the inner and outer preforms escapes as the preforms are stretched and blown.

A cap, not shown, screwed onto the threading 86, carries a seal which isolates the compartments from one another. Removal of the cap enables the two compartments to be emptied.

It is also possible for the cap to be such that access can be had to a selected one of the compartments to enable the product in that compartment to be used. For example, the threading 86 can be omitted and the cap can be a “snap-on” cap. Such a cap can be retained by an additional encircling bead and is able to rotate on the bottle but not to unscrew. The cap can have a dispensing opening in it which can be aligned with the selected compartment.

1. Compression moulding apparatus which comprises a female mould with a vertical passageway therethrough, a male mould which is above the female mould, means for displacing the male mould and female mould into contact to close the upper end of said passageway and partially to define a mould cavity within the female mould, a plunger, means for displacing the plunger and female mould relatively to one another so that the plunger enters the lower end of said passageway, the upper end of the plunger being in the form of a well for receiving a charge of synthetic plastics material before the plunger enters said passageway, and means for feeding a charge of synthetic plastics material to said well.

2. Apparatus as claimed in claim 1, wherein said well is constituted by a depression in the top surface of said plunger.

3. Apparatus as claimed in claim 1, wherein said plunger comprises a shaft and a ring, the radially inner surface of the ring and the top surface of the shaft constituting said well whilst the ring protrudes upwardly above the top surface of said shaft.

4. Apparatus as claimed in claim 1, and including means for displacing said male mould up and down with respect to the female mould.

5. Apparatus as claimed in claim 1, and including means for displacing said plunger up and down with respect to the female mould.

6. A compression moulding method which comprises bringing a male mould member and female mould member into contact whereby the male mould member closes the upper end of a passageway extending through the female mould member, surfaces of the contacting mould members constituting part of the bounding wall of a mould cavity, feeding a charge of synthetic plastics material onto the top surface of a plunger, inserting the plunger into the lower end of said passageway thereby to place said charge of synthetic plastics material in said passageway, displacement of said plunger and the female mould relatively to one another continuing until the upper surface of the plunger reaches a position in which it constitutes the remaining part of the bounding wall of the mould cavity.

7. A method as claimed in claim 6, wherein the male mould member moves downwardly towards said female mould member to close said upper end of said passageway, and the plunger moves upwardly towards said female mould member to insert said Charge of plastics material into the passageway.

8. A method of producing a bottle the wall of which comprises more than one layer of synthetic plastics material, the method comprising moulding a first preform which is open at one end and closed at the other, moulding a second preform which is open at one end and closed at the other, the external dimensions of the second preform being compatible with the internal dimensions of the first preform, inserting the second preform into the first preform and blowing the performs to form the bottle.

9. A method as claimed in claim 8, wherein the first preform has a radially outwardly protruding flange adjacent the open end thereof.

10. A method as claimed in claim 8, wherein the internal dimension of the first preform is greater adjacent its open end than elsewhere whereby there is an annular gap between the first and second preforms adjacent the open end of the first preform.

11. A method as claimed in claim 8 wherein the second perform has threading on the external surface thereof adjacent said open end and an encircling cap retaining bead positioned between the threading and the remainder of the preform.

12. A method as claimed in claim 8, with the modification that two second preforms are inserted into the first preform whereby the bottle blown has an internal partition.

13. A blown bottle having a multi-layer wall when produced by the method claimed in claim 8.
